(19) United States
(12) Patent Application Publication
(10) Pub. No.: US 2017/0048901 A1
(43) Pub. Date: Feb. 16, 2017

(54) METHOD FOR ASSOCIATING A MOBILE DEVICE WITH AN APPLIANCE

(71) Applicant: General Electric Company, Schenectady, NY (US)

(72) Inventors: Michael F. Finch, Pineville, NC (US); Jeff D. Drake, Louisville, KY (US); Dong Hun Lee, Gunpo-si (KR); Shelly E. Warms, Louisville, KY (US)

(21) Appl. No.: 14/822,145

(22) Filed: Aug. 10, 2015

(51) Int. Cl. H04W 76/02; H04W 12/06

(52) U.S. Cl. CPC H04W 76/023; H04W 12/06

(57) ABSTRACT

A method for associating a mobile device with an appliance includes capturing an image of a graphic identifier on the appliance with a camera of the mobile device, identifying a credential within the image of the graphic identifier, and establishing a wireless connection between the appliance and the mobile device if the credential from the step of identifying is correct.

### FIELD OF THE INVENTION

The present subject matter relates generally to appliances, mobile devices and methods for associating mobile devices with appliances.

### BACKGROUND OF THE INVENTION

Residential, commercial, and industrial locations can include a variety of appliances. For example, refrigerator appliances, microwave appliances, oven appliances, water heater appliances, HVAC appliances and the like can be provided at such locations. Conventionally, such appliances were stand alone and incapable of communicating with any other device.

More recently, appliances have included network interfaces and microcontrollers or microprocessors that allow the appliances to communicate with one another and other devices over the network. Such communications can facilitate operation of the appliances. However, such communications have been limited, and verifying that such communications come from trusted sources can be difficult.

Thus, a method for associating a mobile device with an appliance would be useful. In particular, a method for associating a mobile device with an appliance prior to permitting operation of the appliance with the mobile device would be useful.

### BRIEF DESCRIPTION OF THE INVENTION

The present subject matter provides a method for associating a mobile device with an appliance. The method includes capturing an image of a graphic identifier on the appliance with a camera of the mobile device, identifying a credential within the image of the graphic identifier, and establishing a wireless connection between the appliance and the mobile device if the credential from the step of identifying is correct. Additional aspects and advantages of the invention will be set forth in part in the following description, or may be apparent from the description, or may be learned through practice of the invention.

In a first exemplary embodiment, a method for associating a mobile device with an appliance is provided. The method includes capturing an image of a graphic identifier on the appliance with a camera of the mobile device, identifying a credential within the image of the graphic identifier with the mobile device, and establishing a wireless connection between the appliance and the mobile device if the credential from said step of identifying is correct.

In a second exemplary embodiment, a method for associating a mobile device with an appliance is provided. The method includes signing into an account at a cloud service provider with the mobile device. The account is associated with an authorized user of the appliance. The method further includes capturing an image of a graphic identifier on the appliance with a camera of the mobile device after the step of signing into, identifying a credential within the image of the graphic identifier, and establishing a wireless connection between the appliance and the mobile device if the credential from the step of identifying is correct.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a schematic view of an appliance according to an exemplary embodiment of the present subject matter and a mobile device according to an exemplary embodiment of the present subject matter.

FIG. 2 illustrates a method for associating a mobile device with an appliance according to an exemplary embodiment of the present subject matter.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

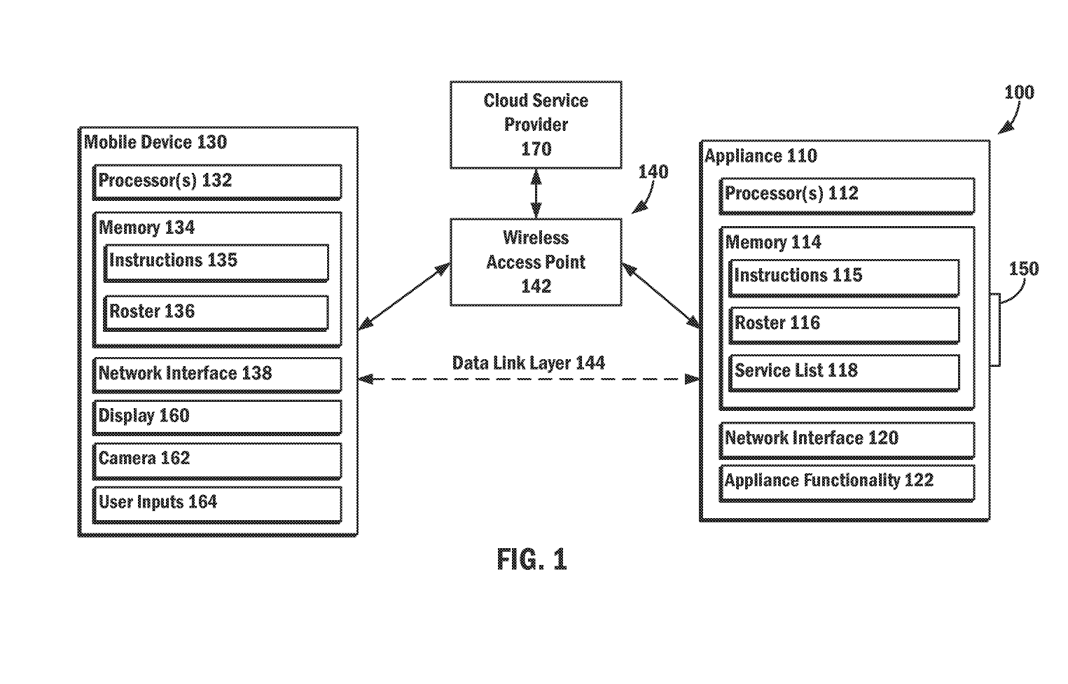

FIG. 1 provides a schematic view of a system 100 for operating an appliance 110 according to an exemplary embodiment of the present subject matter. System 100 includes stations, such as appliance 110 and a mobile device 130. Appliance 110 and mobile device 130 are in communication with one another, e.g., via a network 140. As discussed in greater detail below, system 100 includes features for associating mobile device 130 with appliance 110, e.g., such that mobile device 130 may operate appliance 110. Thus, a location and/or user of mobile device 130 may be verified before permitting operation of appliance 110 with mobile device 130.

Appliance 110 includes one or more processors 112, a memory 114, and a network interface 120, and provides appliance functionality 122. As used herein, an appliance can be any machine or device for performing a specific task, including, without limitation, an air conditioner, an HVAC system controller, a security system, a ceiling fan, a clothes dryer, a clothes washer, a dishwasher, a refrigerator, a lighting system, a stove, an oven, a thermostat, a water heater, a video display appliance (such as a television), an audio emitter appliance (such as a stereo system) or any other suitable appliance.

Network interface 120 of appliance 110 can include any suitable components for interfacing with one more networks, such as network 140. For example, network interface 120 of appliance 110 may include transmitters, receivers, ports, controllers, antennas, or other suitable components.

The processor(s) 112 of appliance 110 can be any suitable processing device, such as a microprocessor, microcontroller, integrated circuit, or other suitable processing device. The memory 114 of appliance 110 can include any suitable computing system or media, including, but not limited to, non-transitory computer-readable media, RAM, ROM, hard drives, flash drives, or other memory devices. The memory 114 of appliance 110 can store information accessible by processor(s) 112 of appliance 110, including instructions 115 that can be executed by processor(s) 112 of appliance 110 to control various components of appliance 110 to provide appliance functionality 122.

Mobile device 130 includes one or more processors 132 and a memory 134. The processor(s) 132 of mobile device 130 can be any suitable processing device, such as a microprocessor, microcontroller, integrated circuit, or other suitable processing device. The memory 134 of mobile device 130 can include any suitable computing system or media, including, but not limited to, non-transitory computer-readable media, RAM, ROM, hard drives, flash drives, or other memory devices. The memory 134 of mobile device 130 can store information accessible by processor(s) 132 of mobile device 130, including instructions 135 that can be executed by processor(s) 132 of mobile device 130 to control various components of mobile device 130. The mobile device 130 can be any suitable type of mobile computing device, such as a general purpose computer, special purpose computer, laptop, integrated circuit, smartphone, tablet, wearable computing device, or other suitable mobile computing device.

Network interface 138 of mobile device 130 can include any suitable components for interfacing with one more networks, such as network 140. For example, network interface 138 of mobile device 130 may include transmitters, receivers, ports, controllers, antennas, or other suitable components.

As discussed above, appliance 110 and mobile device 130 are in communication with one another via network 140. The network 140 can be any type of communications network, such as a local area network (e.g. intranet), wide area network (e.g. Internet), or some combination thereof. The network 140 includes a wireless access point 142 and/or a data link layer 144 for placing appliance 110 and mobile device 130 in communication with one another. Thus, appliance 110 and mobile device 130 can be in indirect communication with one another via wireless access point 142. Further, appliance 110 and mobile device 130 can be in direct communication with one another via data link layer 144. In general, communication between appliance 110 and mobile device 130 can be carried via associated network interfaces using any type of wireless connection, using a variety of communication protocols (e.g. TCP/IP, HTTP), encodings or formats (e.g. HTML, XML), and/or protection schemes (e.g. VPN, secure HTTP, SSL). In particular, the network 140 may be a wireless local area network (WLAN) configured to conform to IEEE 802.11.

Mobile device 130 also includes a display 160 for presenting information to a user of mobile device 130 and an optical reader or camera 162 for capturing images. Display 160 may present images from camera 162 to the user of mobile device 130, e.g., in order to allow the user to aim camera 162 and/or review images captured with camera 162. Display 160 may include, for example, a liquid crystal display panel (LCD), a plasma display panel (PDP), or any other suitable mechanism for displaying an image. Camera 162 may be any type of device suitable for capturing an image, such as a still image and/or moving image. As an example, camera 162 may be a video camera or a digital camera with an electronic image sensor, e.g., a charge coupled device (CCD) or a CMOS sensor.

Mobile device 130 further includes a user interface 164. User interface 164 is configured for permitting a user of mobile device 130 to manage operation of mobile device 130, e.g., camera 162 and/or display 160. User interface 164 may include any suitable type of interface, such as a touch screen, a keypad, knobs, sliders, buttons, speech recognition, etc., that permits a user to input control commands for mobile device 130.

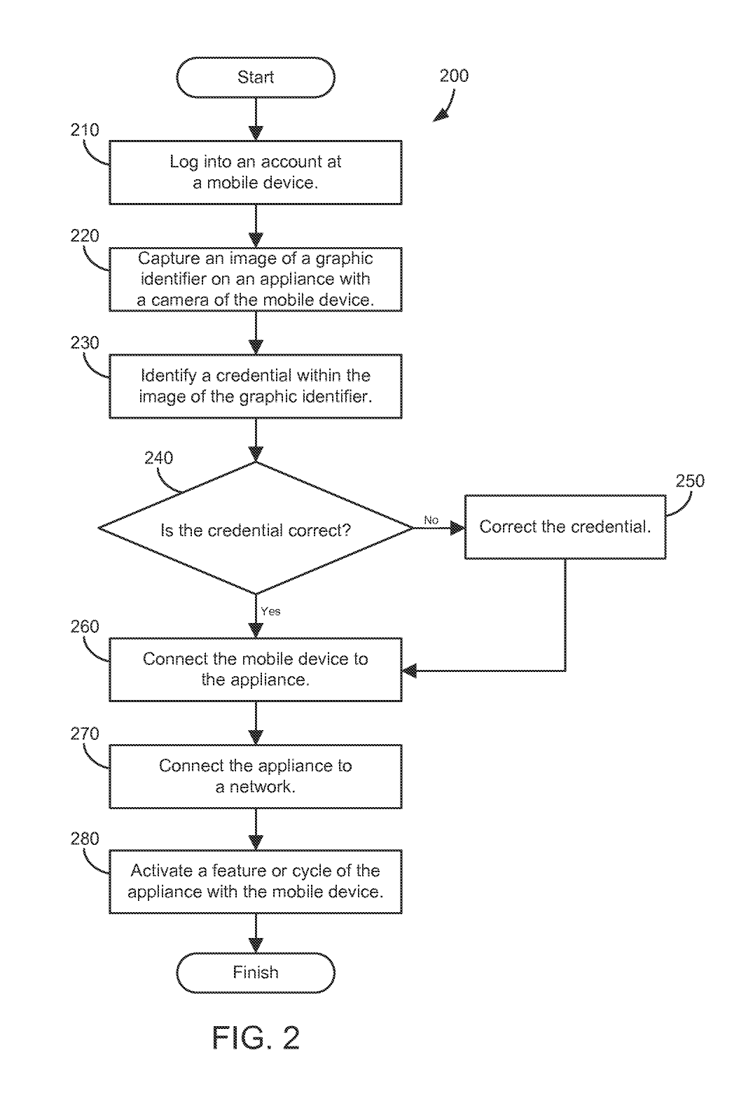

FIG. 2 illustrates a method 200 for associating a mobile device with an appliance according to an exemplary embodiment of the present subject matter. Method 200 may be used with any suitable appliance and mobile device. For example, method 200 may be used with system 100. In particular, appliance 110 and/or mobile device 130 may be programmed to implement method 200, e.g., such that at least portions of method 200 are implemented as an application on mobile device 130. Utilizing method 200, mobile device 130 may be associated with appliance 110, e.g., such that appliance 110 and mobile device 130 communicate with each other over network 140 and/or mobile device 130 may activate various features of appliance 110, as discussed in greater detail below.

At step 210, a user of mobile device 130 may sign or log into an account at a cloud service provider 170 with mobile device 130. The account may be associated with an owner or authorized user of appliance 110. For example, when appliance 110 is purchased, the account may be created such that the account is associated with the owner or an authorized user of appliance 110. Cloud service provider 170 may be any suitable service accessible with mobile device 130, e.g., via network 140. For example, cloud service provider 170 may be a website provided by a manufacturer or seller of appliance 110.

Step 210 may assist with verifying an identity of a user of mobile device 130. Thus, prior to permitting subsequent steps of method 200 to be implemented on mobile device 130, an identity of the user of mobile device 130 may be verified or checked by requiring signing onto the account at step 210, and step 210 may assist with limiting unauthorized association of mobile devices with appliance 110. It should be understood that step 210 may be omitted in certain exemplary embodiments.

At step 220, an image of a graphic identifier 150 on appliance 110 is captured with camera 162 of mobile device 130. Graphic identifier 150 may be any suitable type of graphical identifier. For example, graphic identifier 150 may be a string of characters, and the string of characters may include at least one of a letter, a number or a punctuation mark. The string of characters may have any suitable length. As an example, the string of characters may include at least four characters, at least five characters, at least eight characters, at least ten characters, at least twenty characters, etc. Graphic identifier 150 may also be a linear bar code or a matrix bar code. Graphic identifier 150 may be positioned at any suitable location on appliance 110. For example, graphic identifier 150 may be a sticker positioned on an outer surface of appliance 110 or an inner surface of appliance 110 or may be directly printed onto such locations on appliance 110.

Step 220 may assist with verifying a position of mobile device 130 relative to appliance 110. In particular, step 220 may assist with insuring that mobile device 130 is positioned proximate appliance 110 and/or that the user of mobile device 130 has physical access to appliance 110. Thus, because graphic identifier 150 is positioned on appliance 110, step 220 may assist with limiting unauthorized association of mobile devices with appliance 110.

At step 230, a credential within the image of graphic identifier 150 from step 220 is identified. The credential corresponds to graphic identifier 150. Thus, the credential may be a string of characters, linear bar code or matrix bar code within the image of graphic identifier 150 from step 220. As an example, an optical character recognition program (OCR) of mobile device 130 may analyze or scan the image of graphic identifier 150 from step 220 in order to identify the credential, e.g., if graphic identifier 150 is a string of characters. As another example, a suitable barcode reader program of mobile device 130 may analyze or scan the image of graphic identifier 150 from step 220 in order to identify the credential, e.g., if graphic identifier 150 is a linear bar code or matrix bar code.

The credential within the image of graphic identifier 150 from step 220 may be identified using any suitable method or mechanism at step 230. As discussed above, mobile device 130 may analyze the image of graphic identifier 150 from step 220 in order to identify the credential. As another example, cloud service provider 170 may analyze the image of graphic identifier 150 from step 220 in order to identify the credential. Step 230 may also assist with verification of mobile device 130. In particular, identifying the credential within the image of graphic identifier 150 from step 220 may limit manual entry of a long string of characters. In such a manner, user frustration with the association and/or verification process can be avoided or limited.

At step 240, the image of graphic identifier 150 from step 220 and/or the credential from step 230 may be presented on display 160 of mobile device 130. During step 240, a user of mobile device may verify or check that the credential from step 230 matches or corresponds to graphic identifier 150. If the user of mobile device 130 sees that the credential from step 230 matches or corresponds to graphic identifier 150, method 200 proceeds to step 260. Conversely, if the user sees that a character within a string of characters of the credential from step 230 is incorrect relative to graphic identifier 150 at step 250, method 200 proceeds to step 250. At step 250, the credential from step 230 is corrected. As any example, a user of mobile device 130 may manually modify the credential with user interface 164 of mobile device 130 at step 250, e.g., if the credential is a string of characters. After the credential is corrected at step 250, method 200 proceeds to step 260.

At step 260, a wireless connection is established between appliance 110 and mobile device 130. Thus, after identifying the credential at step 230, wireless communication between appliance 110 and mobile device 130 may be established. It should be understood that appliance 110 will not establish the wireless connection with mobile device 130 unless the credential is correct. Any suitable type of wireless connection may be established between appliance 110 and mobile device 130 at step 260. For example, wireless access point 142 may provide the wireless connection between appliance 110 and mobile device 130 at step 260. As another example, data link layer 144 may provide the wireless connection between appliance 110 and mobile device 130 at step 260.

At step 270, appliance 110 is connected to network 140. In particular, mobile device 130 may assist with connecting appliance 110 to network 140 at step 270. For example, a user of mobile device 130 may select network 140 for appliance 110 on mobile device 130 at step 270, and the user of mobile device 130 may enter an associated password for network 140 on mobile device 130, e.g., via user interface 164. Connecting appliance 110 to network 140 may permit operation of appliance 110 with mobile device 130 when mobile device 130 is remotely positioned relative to appliance 110, as discussed in greater detail below.

At step 280, a feature or cycle of appliance 110 is activated or deactivated with mobile device 110. Any suitable feature, function or cycle of appliance 110 may be activated or deactivated at step 280. For example, a wash cycle of the appliance 110 may be started or stopped at step 280, e.g., if appliance 110 is a dishwasher appliance or a washing machine appliance. As another example, a cook cycle of appliance 110 may be started or stopped at step 280, e.g., if appliance 110 is an oven appliance or a cooktop appliance. As another example, the function may be activating or deactivating appliance 110, e.g., if appliance 110 is an HVAC appliance. As another example, the function may be alerting a user of mobile device 130 that a water filter of appliance 110 needs replacing, e.g., if appliance 110 is a refrigerator appliance. As another example, the function may be alerting the user of mobile device 130 that appliance 110 is activated or hot, e.g., if appliance 110 is a cooktop appliance or an oven appliance. As yet another example, the function may be alerting the user of mobile device 130 that appliance 110 is malfunctioning. It should be understood that the above examples are provided by way of example only and that any other suitable feature, function or cycle of appliance 110 may be activated or deactivated at step 280. At step 280, mobile device 130 may be position proximate or remotely relative to appliance 110. Network 140 allows commands to be transmitted from mobile device 130 to appliance 110 when mobile device 130 is positioned proximate appliance 110 (e.g., within the same building) and when mobile device 130 is positioned far from appliance 110 (e.g., not within the same building).

As may be seen from the above discussion of method 200, method 200 assists with associating mobile device 130 with appliance 110. In particular, method 200 may assist with avoiding unauthorized use of appliance 110 while also facilitating the verification process by limiting or reducing manual entry of passwords.

Network 140 permits communication with cloud service provider 170. Cloud service provider 170 may be configured for implementing at least a portion of method 200. Thus, it should be understood that method 200 may be implemented as a cloud-based service.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. A method for associating a mobile device with an appliance, the mobile device including a display, the method comprising:
capturing an image of a graphic identifier on the appliance with a camera of the mobile device;
identifying a credential within the image of the graphic identifier to provide an identified credential;
presenting, on the display of the mobile device, both the image of the graphic identifier from said step of capturing and the identified credential from said step of identifying;
correcting the identified credential if the identified credential from said step of identifying does not match the graphic identifier within the image of the graphic identifier from said step of capturing, wherein correcting the identified credential includes manually modifying the identified credential according to a user input of the mobile device; and
establishing a wireless connection between the appliance and the mobile device if the identified credential is correct relative to the graphic identifier.

2. (canceled)

3. (canceled)

4. (canceled)

5. The method of claim 1, wherein the graphic identifier is a string of characters, the string of characters including at least one of a letter, a number or a punctuation mark.

6. The method of claim. 1, wherein the graphic identifier is a linear bar code or a matrix bar code.

7. The method of claim 1, further comprising connecting the appliance to a network after said step of establishing.

8. The method of claim 7, wherein said step of connecting comprising entering a password for the network on the mobile device.

9. The method of claim 1, further comprising activating a feature or cycle of the appliance with the mobile device after said step of establishing.

10. The method of claim 9, wherein said step of activating comprises initiating a wash cycle of the appliance or a cook cycle of the appliance.

11. A method for associating a mobile device with an appliance, the mobile device including a display, the method comprising:
signing into an account at a cloud service provider with the mobile device, the account associated with an authorized user of the appliance;
capturing an image of a graphic identifier on the appliance with a camera of the mobile device after said step of signing into;
identifying a credential within the image of the graphic identifier to provide an identified credential;
presenting, on the display of the mobile device, both the image of the graphic identifier from said step of capturing and the identified credential from said step of identifying;
correcting the identified credential if the identified credential from said step of identifying does not match the graphic identifier within the image of the graphic identifier from said step of capturing, wherein correcting the identified credential includes manually modifying the identified credential according to a user input of the mobile device; and
establishing a wireless connection between the appliance and the mobile device if the identified credential is correct relative to the graphic identifier.

12. (canceled)

13. (Canceled)

14. (Canceled)

15. The method of claim 11, wherein the graphic identifier is a string of Characters, the string of characters including at least one of a letter, a number or a punctuation mark.

16. The method of claim 11, wherein the graphic identifier is a linear bar code or a matrix bar code.

17. The method of claim 11, further comprising connecting the appliance to a network after said step of establishing.

18. The method of claim 17, wherein said step of connecting comprising entering a password for the network on the mobile device.

19. The method of claim 11., further comprising activating a feature or cycle of the appliance with the mobile device after said step of establishing.

20. The method of claim 19, wherein said step of activating comprises initiating a wash cycle of the appliance or a cook cycle of the appliance.
